(19) United States
(12) Patent Application Publication
(10) Pub. No.: US 2010/0201264 A1
(43) Pub. Date: Aug. 12, 2010

(54) PLASMA DISPLAY PANEL

(75) Inventor: Tae-Joung KWEON, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/698,380

(22) Filed: Feb. 2, 2010

(30) Foreign Application Priority Data
Feb. 12, 2009 (KR) 10-2009-0011495

(51) Int. Cl. H01J 17/49

(52) U.S. Cl. 313/586

(57) ABSTRACT

A plasma display panel includes a first substrate; a second substrate spaced apart from the first substrate and disposed to face the first substrate; a plurality display electrodes formed on the first substrate; a first dielectric layer formed on the first substrate and disposed to cover the display electrodes; a protective layer formed on the first substrate and disposed to cover the first dielectric layer; and barrier ribs disposed to define discharge cells in between the first and second substrates. At least a portion of the first dielectric layer is colored with a first color, at least portions of the barrier ribs are colored with a second color that is substantially complementary to the first color, and a difference between refractive indices of the first dielectric layer and the protective layer to be less than or equal to 0.5.

### CROSS-REFERENCE TO RELATED APPLICATIONS

This application claims the benefit of Korean Patent Application No. 10-2009-0011495, filed on Feb. 12, 2009, in the Korean Intellectual Property Office, the disclosure of which is incorporated herein by reference.

### BACKGROUND OF THE INVENTION

1. Field of the Invention

Aspects of the present invention relate to a plasma display panel (PDP), and more particularly, to a PDP that reduces color stain on the PDP by using a complementary color panel and a difference between the refractive indices of a dielectric layer and a protective layer.

2. Description of the Related Art

Plasma display panels (PDPs), which are being used as a replacement for conventional cathode ray tubes (CRTs), are display devices that display images by applying a discharge voltage to a discharge gas between two substrates, using a plurality of electrodes formed on the substrates, to generate ultraviolet (UV) rays, which excite a phosphor material to generate visible light.

Such PDPs include a front substrate and a rear substrate that face each other, which are spaced apart from each other, a plurality of barrier ribs that are installed between the front and rear substrates and defines a plurality of discharge cells in which gas discharge is generated, a discharge gas that fills the discharge cells, a phosphor material coated on the inner surfaces of the discharge cells, and electrodes to which a voltage is applied to generate discharges of the discharge gas within the discharge cells.

In recent developments of PDPs, efficiency improvement is an important issue. To achieve an improved efficiency, a method of increasing the amount of a Xe discharge gas within a panel has been generally used in order to increase the brightness of the panel while reducing power consumption.

However, when the amount of the Xe discharge gas is increased, the discharge voltage is also increased, and color stain, which at low amounts of discharge gas is not an issue, occurs due to an increase of the brightness. Color stain refers to a phenomenon that when a full white pattern, which makes the entire panel appear white, is formed on a PDP, the PDP appears to display colors other than white in portions thereof, and thus a deviation from a full white pattern is generated.

### SUMMARY OF THE INVENTION

Aspects of the present invention provide a plasma display panel including a first substrate; a second substrate spaced apart from the first substrate and disposed to face the first substrate; a plurality of display electrodes formed on the first substrate; a first dielectric layer formed on the first substrate and disposed to cover the display electrodes; a protective layer formed on the first substrate and disposed to cover the first dielectric layer; and a plurality of barrier ribs disposed to define discharge cells in between the first and second substrates, wherein at least a portion of the first dielectric layer is colored with a first color, at least portions of the barrier ribs are colored with a second color that is substantially complementary to the first color, and a difference between refractive indices of the first dielectric layer and the protective layer to be less than or equal to 0.5.

According to aspects of the present invention, the first color may include blue and the second color may include brown.

According to aspects of the present invention, the external light reflection brightness of the plasma display panel may be 8 cd/m² to 16 cd/m². According to aspects of the present invention, the external light reflection brightness of the plasma display panel may be 8.7 cd/m² to 15.6 cd/m².

According to aspects of the present invention, the protective layer may be formed of a material including magnesium oxide (MgO). According to aspects of the present invention, the refractive index of the protective layer may be 1.56 to 1.61.

According to aspects of the present invention, the plasma display panel may further include phosphor layers formed within the discharge cells; address electrodes formed on the second substrate; and a second dielectric layer formed on the second substrate and disposed to cover the address electrodes.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages will become apparent and more readily appreciated from the following description of exemplary embodiments, taken in conjunction with the accompanying drawings, of which:

FIG. 1 is a partially exploded perspective view of a plasma display panel (PDP) according to an exemplary embodiment;

FIG. 2 is a graph showing the variation of sensitivity of color perception and the fluctuation of brightness; and

FIG. 3 is a color wheel illustrating a complementary relationship between colors.

### DETAILED DESCRIPTION OF THE EMBODIMENTS

Reference will now be made in detail to exemplary embodiments, examples of which are illustrated in the accompanying drawings, wherein like reference numerals refer to the like elements throughout. Exemplary embodiments are described below in order to explain aspects thereof with reference to the figures. Herein, when a first element is referred to as being “formed on” or “disposed on” a second element, the first element can be formed directly on or disposed directly on the second element, or one or more other elements may be disposed therebetween. When a first element is referred to as being “formed directly on” or “disposed directly on” a second element, no other elements are disposed therebetween. In the drawings, the lengths or thicknesses of layers and regions are exaggerated for clarity.

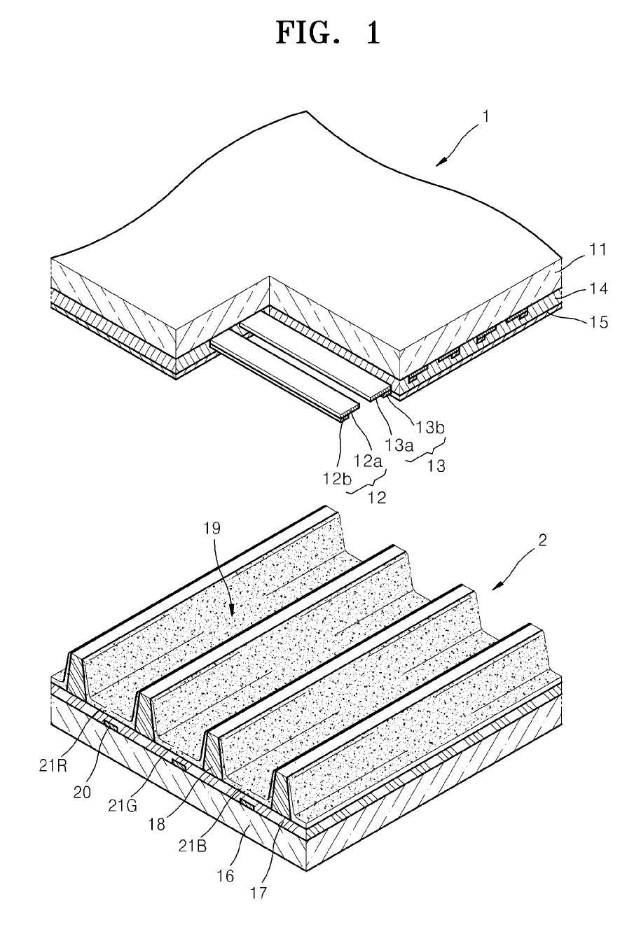

FIG. 1 is a partially exploded perspective view of a structure of a plasma display panel (PDP) according to an exemplary embodiment. Referring to FIG. 1, the PDP includes a front panel 1 and a rear panel 2. A first substrate 11 of the front panel 1 is spaced apart from and opposite to a second substrate 16 of the rear panel 2. A plurality of pairs of display electrodes 12 and 13 include bus electrodes 12b and 13b disposed on transparent electrodes 12a and 13a and are formed on the lower surface of the first substrate 11, i.e., the surface of the first substrate 11 facing the rear panel 2. The display electrodes 12 include the transparent electrodes 12a and the bus electrodes 12b, and the display electrodes 13 include the transparent electrodes 13a and the bus electrode 13b. A first dielectric layer 14 is formed on the first substrate 11 and covers the display electrodes 12 and 13. A protective layer 15 is formed on the first dielectric layer 14. A plurality of address electrodes 20 is formed on the upper surface of the second substrate 16, i.e., on the surface of the second substrate 16 that faces the front panel 1. The second dielectric layer 17 is formed on the second substrate 16 and covers the address electrodes 20. Barrier ribs 18 are formed between the first substrate 11 and the second substrate 16 so as to partition a discharge space into a plurality of discharge cells 19. Phosphor layers 21R, 21G, and 21B are coated on the inner surfaces of the discharge cells 19 defined by the barrier ribs 18.

Focusing on the optical characteristics of the front panel 1, optical interference occurs between the protective layer 15 and the first dielectric layer 14 because the protective layer 15 is thin. The optical interference depends on the thickness of the protective layer 15. If the thickness of the protective layer 15 is not uniform, interference is also non-uniform, and thus the transmittance of the front panel 1 is non-uniform. The non-uniform transmittance causes color stain, in which the panel of a PDP does not look entirely white but is partially multi-colored when displaying a full white pattern. This is referred to as bad white uniformity. A method of maintaining the thickness of a protective layer constant may be considered to prevent non-uniform interference that results in bad white uniformity. However, in a process of forming a protective layer with a uniform thickness, if a process condition is not stable, quality deviation related to color stain may occur, and accordingly the improvement of the quality deviations with respect to uniformity of thickness of the protective layer has limitations. As such, it is difficult to control color stain by forming a protective layer having a uniform thickness. However, since the non-uniformity of transmittance is correlated to a difference between refractive indices of media, i.e., the materials from which the protective layer and the first dielectric layer are formed, the degree of color stain may be decreased by controlling the difference between the refractive indices of the media.

Non-uniform interference is caused by optical interference, which results in non-uniform transmittance of light, and is correlated to a difference between refractive indices of the protective layer 15 and the first dielectric layer 14. Here, the refractive index denotes a ratio of the speed of light in a vacuum c to a speed (phase velocity) of light in a medium v, that is, (c/v). Thus, the refractive index of the first dielectric layer 14 is a ratio of the speed of light in a vacuum c to the speed of light in the first dielectric layer 14 (v₁₄), and the refractive index of the protective layer 15 is a ratio of the speed of light in a vacuum c to the speed of light in the protective layer 15 (v₁₅). If the difference between the refractive indices of the first dielectric layer 14 and the protective layer 15 is small, the influence of interference is decreased, and substantial non-uniformity is removed, so that color stain is reduced. On the other hand, if the difference between the refractive indices of the first dielectric layer 14 and the protective layer 15 is large, the amplitude of interference is increased, non-uniform transmittance is generated, and color stain occurs.

The protective layer 15 may be formed of a material including MgO. MgO is excellent in terms of a secondary electron emission coefficient and sputtering resistance. Since the refractive index of MgO varies minutely according to its crystallinity and density but is maintained constant in the range of about 1.56 to about 1.61, it is not easy to change the refractive index of an MgO thin film to be close to the refractive index of the first dielectric layer 14 so as to reduce the difference between the refractive indices of the MgO protective layer 15 and the first dielectric layer 14. Accordingly, in this exemplary embodiment, the refractive index of the first dielectric layer 14 is controlled to be close to the refractive index of the MgO protective layer 15 by controlling the material composition of the first dielectric layer 14. The first dielectric layer 14 may include at least one component selected from the group consisting of ZnO, CaO, and Al₂O₃ so as to change the refractive indices thereof. Although a refractive index of the first dielectric layer 14, which is generally and currently used in PDPs, is about 1.9, the refractive index of the first dielectric layer 14 may be approximated to be about the same as the refractive index of the MgO protective layer 15 because the material composition of the first dielectric layer 14 can be more widely changed than the MgO protective layer 15.

In addition to reducing the difference between the refractive indices of the first dielectric layer 14 and the protective layer 15, thereby reducing color stain by controlling the composition of the first dielectric layer 14, external light reflection brightness may additionally be considered in order to solve a color stain problem. The external light reflection brightness is an attribute of visual perception describing light being reflected from a panel in a dark room when the panel is exposed to natural light at 150 lux. Such may be considered in solving a color stain problem because although color stain exists, color stain visually perceived from a panel can be concealed by adding a color to the panel to darken the panel and lower the external light reflection brightness. The use of a complementary panel may be considered as a method to decrease the external light reflection brightness.

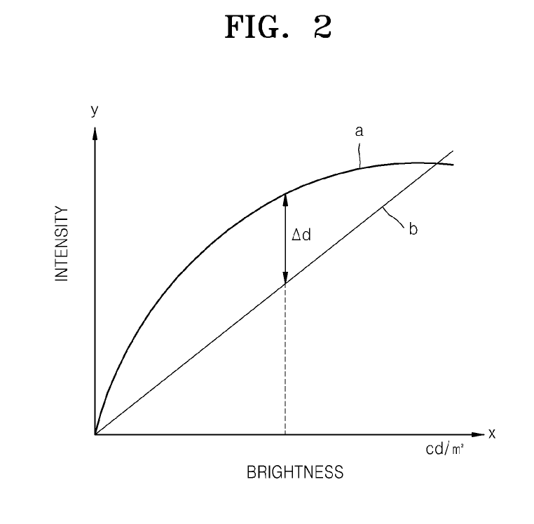

FIG. 2 is a graph showing the variation of sensitivity of color perception (Graph (a)) and the fluctuation of brightness (Graph (b)). Graph (a) describes how the human eye perceives color. Graph (b) shows intensities of light according to a variation of a real brightness value. Referring to FIG. 2, the intensity difference (Δd) between the real brightness and the perceived color brightness varies with the brightness along the x-axis. The effects of reducing color stain with respect to certain refractive indices may increase when the intensity difference (Δd) is in a certain range where the intensity difference (Δd) has a relatively greater value. In other words, since a difference between refractive indices causes certain effects in reducing the color stain, and also because the human eye becomes more sensitive when the intensity difference (Δd) has a relatively greater value, the effects in reducing the color stain according to the difference between the refractive indices are greater on the human eye.

On the other hand, taking into consideration the effects in reducing the color stain by brightness, a smaller brightness would cause higher effects in reducing the color stain. Thus, referring to FIG. 2, at a certain point where the brightness is in a certain range determined by the intensity difference (Δd) and the brightness itself, the effects in reducing the color stain would be maximized.

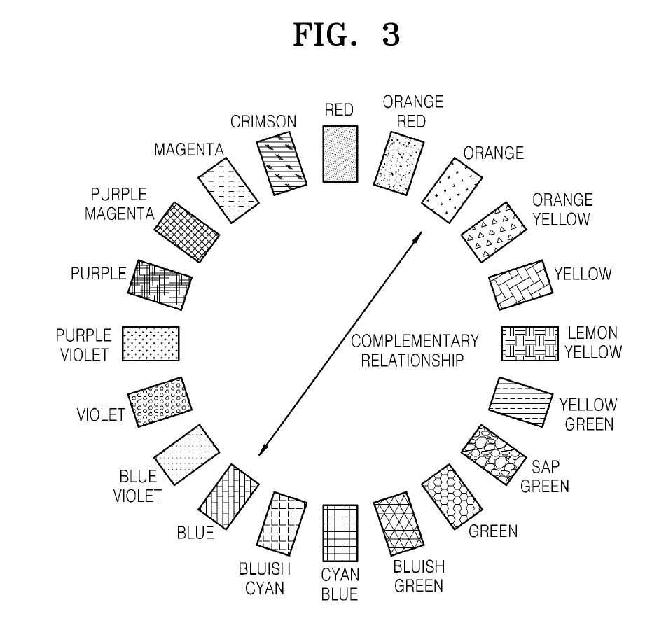

The complementary panel is a PDP in which at least a portion of the first dielectric layer 14 is colored with a first color and at least portions of the barrier ribs 18 are colored with a second color that is substantially complementary to the first color. FIG. 3 is a color wheel illustrating a complementary relationship between colors. Complementary colors are any two colors whose proportional mixture produces an achromatic color, such as black or gray. Complementary colors are located directly across from each other on the color wheel. Examples of complementary colors include a pair of red and cyan blue, a pair of orange and blue, a pair of yellowish green and purple, and the like. Although not shown on the color wheel of FIG. 3, black and white are complementary to each other, there are numerous complementary colors, and a mixture of colors having a quasi-complementary relationship, i.e., not a complementary relationship, gives a color close to black. For example, in FIG. 3, orange red is not complementary to blue, but is close to orange, which is complementary to blue. A mixture of blue and orange red produces a color close to black. Accordingly, if the color of the barrier ribs 18 is an orange-series color, the color of the first dielectric layer 14 may be a blue-series color, and if the color of the barrier ribs 18 is a blue-series color, the color of the first dielectric layer 14 may be an orange-series color. Examples of orange-series colors include brown and the like having colors similar to orange. In other words, if the color of the first dielectric layer 14 includes blue, the color of at least portions of the barrier ribs 18 may include brown.

In an exemplary embodiment, the first dielectric layer 14 may have a color including blue, and upper surfaces or the entire surface of the barrier ribs 18 may have a color including brown. However, aspects are not limited to this exemplary embodiment, and any two colors that have a substantially complementary relationship may be used as the colors of the first dielectric layer 14 and the barrier ribs 18. Further, the upper surfaces of the barrier ribs 18 may have a highly reflective color capable of preventing brightness from being decreased due to absorption of light generated by the phosphor layers 21R, 21G, and 21B, and the first dielectric layer 14 may have a color capable of transmitting light generated by the discharge cells 19. Only the upper surfaces or portions of the barrier ribs 18 may be colored, or all of the surfaces of or the entire barrier ribs 18 may be colored.

When external light reflection brightness is decreased by using complementary colors, visually-perceived color stain on the panel can be concealed. According to a result of an experiment made under the conditions of this exemplary embodiment, visually-perceived color stain on the panel was concealed when external light reflection brightness was 8 cd/m² to 16 cd/m² and accordingly, a difference between the refractive indices of the protective layer 15 and the first dielectric layer 14 was allowed to have a maximum margin.

Table 1 shows a result of an experiment on a rate of occurrence of color stain according to a difference between the refractive indices of the protective layer 15 and the first dielectric layer 14 when external light reflection brightness is 8.7 cd/m² of a complementary panel according the aspects of the exemplary embodiments. The rate of occurrence of color stain is the ratio of the number of panels for which color stains occur to the total number of panels.

TABLE 1

| Refractive index of | | |
|---|---|---|
| protective layer | Degree of | Rate of |
| 15 − refractive index of | color stain | occurrence of color |
| first dielectric layer 14 | (high/medium/low) | stain (%) |
| −0.7 | High | 3.7% |
| −0.6 | Medium | 1.9% |
| −0.5 | Low | 0.5% |
| −0.4 | Low | 0.3% |
| −0.3 | Low | 0.2% |
| −0.2 | Zero | Less than 0.1% |
| −0.1 | Zero | Less than 0.1% |
| 0 | Zero | Less than 0.1% |
| 0.1 | Zero | Less than 0.1% |
| 0.2 | Zero | Less than 0.1% |
| 0.3 | Low | 0.3% |
| 0.4 | Low | 0.4% |
| 0.5 | Low | 0.7% |
| 0.6 | Medium | 2.9% |
| 0.7 | High | 4.5% |

Table 2 shows a result of an experiment on a rate of occurrence of color stain according to a difference between the refractive indices of a protective layer and a first dielectric layer when external light reflection brightness is 15.6 cd/m² of a complementary panel according the aspects of the exemplary embodiments.

TABLE 2

| Refractive index of protective | | Rate of |
|---|---|---|
| layer − refractive index of | Degree of color stain | occurrence of |
| first dielectric layer | (high/medium/low) | color stain (%) |
| −0.7 | High | 3.9% |
| −0.6 | Medium | 2.3% |
| −0.5 | Low | 0.9% |
| −0.4 | Low | 0.7% |
| −0.3 | Low | 0.6% |
| −0.2 | Zero | Less than 0.2% |
| −0.1 | Zero | Less than 0.2% |
| 0 | Zero | Less than 0.1% |
| 0.1 | Zero | Less than 0.2% |
| 0.2 | Zero | Less than 0.2% |
| 0.3 | Low | 0.7% |
| 0.4 | Low | 0.8% |
| 0.5 | Low | 0.9% |
| 0.6 | Medium | 3.3% |
| 0.7 | High | 4.8% |

When the rate of occurrence of color stain is less than 1%, color stain is not a problem in terms of white uniformity. Referring to Table 1 or 2, according to a result of an experiment made under the conditions of this exemplary embodiment, in both cases where external light reflection brightness is 8.7 cd/m² and 15.6 cd/m², when a difference between the refractive indices of the protective layer 15 and the first dielectric layer 14 is less than 0.5, the rate of occurrence of color stain is less than 1%.

When the difference between the refractive indices of the protective layer 15 and the first dielectric layer 14 is identical, the higher the external light reflection brightness as shown in Table 2, and the larger the rate of occurrence of color stain. Further, the lower the external light reflection brightness as shown in Table 1, the smaller the rate of occurrence of color stain. For example, in Table 1, when the difference between the refractive indices of the protective layer 15 and the first dielectric layer 14 is −0.5 and the external light reflection brightness is 8.7 cd/m², the rate of occurrence of color stain is 0.5%. However, in Table 2, when the difference between the refractive indices of the protective layer 15 and the first dielectric layer 14 is −0.5 and the external light reflection brightness is 15.6 cd/m², the rate of occurrence of color stain is 0.9%, which is 0.4% higher than the rate of occurrence of color stain of 0.5% of when the external light reflection brightness is 8.7 cd/m². This indicates that high external light reflection brightness causes an increase of the rate of occurrence of color stain, and that the difference between the refractive indices of the protective layer 15 and the first dielectric layer 14 needs to be decreased in order to lower the rate of occurrence of color stain to less than 1%. This also indicates that since low external light reflection brightness causes a decrease of the rate of occurrence of color stain, the difference between the refractive indices may be greater while the rate of occurrence of color stain is within the limit of 1%. As such, by suitably designing the external light reflection brightness of a panel, the rate of occurrence of color stain caused by the difference between the refractive indices of the first dielectric layer 14 and the protective layer 15 may be decreased without greatly changing the material composition of the first dielectric layer 14. However, when the external light reflection brightness is no more than about 8 cd/m², more precisely 8.7 cd/m², the brightness of a PDP is rapidly reduced due to a decrease in the external light reflection brightness of the PDP, and thus the PDP having external light reflection brightness of less than 8 cd/m² is difficult to be applied to actual PDPs. When the external light reflection brightness is no less than about 16 cd/m², more precisely, 15.6 cd/m², the rate of occurrence of color stain is increased, and thus the PDP having external light reflection brightness of more than 16 cd/m² has a critical limit which makes application to actual PDPs difficult. Therefore, when the difference between the refractive indices of the protective layer 15 and the first dielectric layer 14 is no more than about 0.5 and the external light reflection brightness is about 8 cd/m² to about 16 cd/m², an optimal PDP having the rate of occurrence of color stain of less than 1% can be obtained.

In the rear panel 2 of FIG. 1, the address electrodes 20 are formed on the second substrate 16. The second dielectric layer 17 covering the address electrodes 20 is formed on the second substrate 16. When visible light generated in the discharge cells 19 is supposed to propagate toward the first substrate 11, the second dielectric layer 17 does not need to be formed of a transparent material but may be formed of a material that can reflect the visible light toward the first substrate 11. On the other hand, when the visible light is supposed to propagate toward and be transmitted through the second substrate 16, the second dielectric layer 17 may be formed of a transparent material and aspects of the above-described exemplary embodiments may be applied thereto. The barrier ribs 18, which define the discharge cells 19, are formed on the second dielectric layer 17.

R, G, and B phosphors may be coated within the discharge cells 19 sequentially, thereby forming the phosphor layers 21R, 21G, and 21B. The phosphor layers 21R, 21G, and 21B may be formed on the inner walls and bottom surfaces of the discharge cells 19 defined by the barrier ribs 18, but aspects are not limited thereto. When discharge occurs, a photoluminescence (PL) light-emission mechanism occurs in the phosphor layers 21R, 21G, and 21B. In the PL light-emission mechanism, vacuum ultraviolet (UV) rays generated due to discharge excite the electrons of phosphors, which emit visible light when the excited electrons return back to a stable state.

After the first substrate 11 and the second substrate 16 are attached to each other, the internal space of the assembled PDP is filled with air. Then, the air of the internal space of the assembled PDP is completely exhausted, and the assembled PDP is filled with a suitable discharge gas capable of increasing the efficiency of discharge. A mixed gas, such as Ne—Xe, He—Xe, He—Ne—Xe, or the like, may be used as the discharge gas. During a sustain discharge, while excited discharge gas is being stabilized within each of the discharge cells 19, UV rays are generated. The UV rays excite the R, G, and B phosphor layers 21R, 21G, and 21B formed within the discharge cells 19. Red visible light, green visible light, and blue visible light generated respectively from the excited R, G, and B phosphor layers 21R, 21G, and 21B come out of the discharge cells 19, thereby forming a single pixel, which together form images.

Although a few exemplary embodiments have been shown and described, it would be appreciated by those skilled in the art that changes may be made in these exemplary embodiments without departing from the principles and spirit thereof, the scope of which is defined in the claims and their equivalents.

What is claimed is:

1. A plasma display panel, comprising:
a first substrate;
a second substrate spaced apart from the first substrate and disposed to face the first substrate;
a plurality of display electrodes formed on the first substrate;
a first dielectric layer formed on the first substrate and disposed to cover the display electrodes;
a protective layer formed on the first substrate and disposed to cover the first dielectric layer; and
a plurality of barrier ribs disposed to define discharge cells in between the first and second substrates,
wherein at least a portion of the first dielectric layer is colored with a first color, at least portions of the barrier ribs are colored with a second color that is substantially complementary to the first color, and a difference between refractive indices of the first dielectric layer and the protective layer is less than or equal to 0.5.

2. The plasma display panel of claim 1, wherein the first dielectric layer has a refractive index of about 1.06 to about 2.11.

3. The plasma display panel of claim 1, wherein the first dielectric layer comprises at least once component selected from the group consisting of ZnO, CaO, and Al₂O₃.

4. The plasma display panel of claim 1, wherein external light reflection brightness of the plasma display panel is about 8 cd/m² to about 16 cd/m².

5. The plasma display panel of claim 4, wherein the external light reflection brightness of the plasma display panel is about 8.7 cd/m² to about 15.6 cd/m².

6. The plasma display panel of claim 1, wherein the protective layer comprises magnesium oxide (MgO).

7. The plasma display panel of claim 1, wherein the difference between refractive indices of the dielectric layer and the protective layer is less than about 0.34.

8. A plasma display panel, comprising:
a first substrate;
a second substrate spaced apart from the first substrate and disposed to face the first substrate;
a dielectric layer formed on the first substrate;
a protective layer formed on the dielectric layer; and
a plurality of barrier ribs disposed to define discharge cells in between the first and second substrates,
wherein the dielectric layer comprises a blue color, the barrier ribs comprise a brown color, and a difference between refractive indices of the dielectric layer and the protective layer is less than or equal to 0.5.

9. The plasma display panel of claim 8, wherein the protective layer comprises MgO.

10. The plasma display panel of claim 8, wherein the protective layer has a refractive index of about 1.56 to about 1.61.

11. The plasma display panel of claim 8, wherein the dielectric layer has a refractive index of about 1.06 to about 2.11.

12. The plasma display panel of claim 8, wherein the difference between refractive indices of the dielectric layer and the protective layer is less than about 0.34.

13. The plasma display panel of claim 8, wherein the dielectric layer has a refractive index of about 1.27 to less than 1.9.

14. The plasma display panel of claim 8, wherein external light reflection brightness of the plasma display panel is about 8 cd/m² to about 16 cd/m².

15. The plasma display panel of claim 8, wherein the external light reflection brightness of the plasma display panel is about 8.7 cd/m² to about 15.6 cd/m².

16. A plasma display panel, comprising:
a first substrate;
a second substrate spaced apart from the first substrate and disposed to face the first substrate;
a dielectric layer formed on the first substrate;
a protective layer formed on the dielectric layer; and
a plurality of barrier ribs disposed to define discharge cells in between the first and second substrates,
wherein an external light reflection brightness of the plasma display panel is about 8 cd/m² to about 16 cd/m², and a difference between refractive indices of the dielectric layer and the protective layer is less than or equal to 0.5.

17. The plasma display panel of claim 16, wherein the external light reflection brightness of the plasma display panel is about 8.7 cd/m² to about 15.6 cd/m².
